(19) United States
(12) Patent Application Publication
(10) Pub. No.: US 2016/0337213 A1
(43) Pub. Date: Nov. 17, 2016

(54) SYSTEM AND METHOD FOR INTEGRATING COLLABORATION MODES

(71) Applicant: General Electric Company, Schenectady, NY (US)

(72) Inventors: Keith Robert Deutsch, Oakland, CA (US); Sudheer Manoharan Sathi, San Ramon, CA (US); Suparna Pal, Dublin, CA (US); Rajah Kalipatnapu, San Jose, CA (US)

(21) Appl. No.: 14/713,778

(22) Filed: May 15, 2015

(51) Int. Cl. H04L 12/26; H04L 29/08; H04L 29/06

(52) U.S. Cl. CPC H04L 43/045; H04L 65/403; H04L 67/22

(57) ABSTRACT

A system and method for integrating collaboration modes are disclosed. The method includes receiving a first indication of a first synchronous collaboration event for a first workspace, storing a first record of the first synchronous collaboration event in association with the first workspace based on the first indication, receiving a second indication of a second asynchronous collaboration event for the first workspace, storing a second record of the second asynchronous collaboration event in association with the first workspace based on the second indication, and causing a first timeline for the first workspace to be displayed on a computing device. The first timeline may comprise a first graphical representation of the first synchronous collaboration event based on the first record and a second graphical representation of the second asynchronous collaboration event based on the second record.

### TECHNICAL FIELD

The present application relates generally to the technical field of data processing, and, in various embodiments, to a system and method for integrating different collaboration modes.

### BACKGROUND

In the field of collaboration enablement tools, there are two broad classes of such tools, synchronous (e.g., real-time) and asynchronous (non-real-time). Synchronous collaboration tools (e.g., on-demand collaboration, online meeting, web conferencing and videoconferencing applications) enable live interaction between participants in a variety of media modalities. Synchronous collaboration tools provide a context, referred to as a conference, within which live interaction modalities can operate. Asynchronous collaboration tools provide a shared context, referred to as a workspace, within which content can be shared, annotated, commented upon and worked on by participants over time. Participants can enter and leave the workspace at their convenience, and may or may not be present in the workspace at the same time.

In many Field Force Automation (FFA) scenarios, there is a planning phase, an engagement phase, and an execution phase. Each of these phases may involve different sets of several individuals working in collaboration, asynchronously and synchronously, and there can be a handoff between phases where the previous work product must be transferred to the next phase. Additionally, there is often a need to communicate back in real time with the participants in a previous phase, for example to get answers to questions that arise. Moreover, the full set of activities may be repeated again and again with respect to a single target, which history can be valuable and of interest to succeeding cycles of such activities.

In existing platforms and solutions, these collaborative activities are fragmented amongst different tools, the handoff between phases provides no access to the work done in a previous phase, and there is no unified history at all. As a result, communication errors build up, information is lost between phases, work is repeated from phase to phase, and opportunities for learning over time are lost. This deficiencies waste time, slow and degrade decision-making, and increase the likelihood of bad outcomes. There is no existing solution that can tie all of this together and provide a temporal organization that enables all of the resulting information to be manageable and easily discoverable and accessible.

### BRIEF DESCRIPTION

Some or all of the above needs or problems may be addressed by one or more example embodiments. Example embodiments of a system and method for integrating different collaboration modes are disclosed.

In one example embodiment, a computer-implemented method comprises receiving a first indication of a first synchronous collaboration event for a first workspace, and storing a first record of the first synchronous collaboration event in association with the first workspace based on the first indication. The first record can comprise first participant data indicating a first participant of the first synchronous collaboration event, first content data indicating content provided by the first participant during the first synchronous collaboration event, and first temporal data indicating a first time of occurrence of the first synchronous collaboration event. A second indication of a second asynchronous collaboration event for the first workspace is received, and a second record of the second asynchronous collaboration event is stored in association with the first workspace based on the second indication. The second record can comprise second participant data indicating a second participant of the second asynchronous collaboration event, second content data indicating content provided by the second participant during the second asynchronous collaboration event, and second temporal data indicating a second time of occurrence of the second asynchronous collaboration event. A first timeline for the first workspace is caused to be displayed on a computing device. The first timeline can comprise a first graphical representation of the first synchronous collaboration event based on the first record and a second graphical representation of the second asynchronous collaboration event based on the second record.

The above and other features, including various novel details of implementation and combination of events, will now be more particularly described with reference to the accompanying figures and pointed out in the claims. It will be understood that the particular techniques, methods, and other features described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a conceptual diagram illustrating a timeline for a workspace that includes synchronous collaboration events and asynchronous collaboration events, in accordance with some example embodiments;

FIG. 2 is a block diagram illustrating a collaborations services system, in accordance with some example embodiments;

FIG. 3 is a block diagram illustrating components of a workspace services system, in accordance with some example embodiments;

FIG. 4 is a unified modeling language (UML) class diagram for an entity model, in accordance with some example embodiments;

FIG. 5 is a UML class diagram for a workspace shared object, in accordance with some example embodiments;

FIG. 6 is a UML class diagram for an event, in accordance with some example embodiments;

FIG. 7 is a UML class diagram for an actor, in accordance with some example embodiments;

FIG. 8 is a UML class diagram for a workspace, in accordance with some example embodiments;

FIG. 9 is a diagram illustrating workspace use cases, in accordance with some example embodiments;

FIG. 10 is a sequence diagram for a user joining a workspace, in accordance with some example embodiments;

FIG. 11 is a sequence diagram for a user opening a workspace, in accordance with some example embodiments;

FIGS. 12A-12B illustrate a sequence diagram for a user starting a conference, in accordance with some example embodiments;

FIGS. 13A-13B illustrate a sequence diagram for a user starting an audio/video (AV) session, in accordance with some example embodiments;

FIG. 14 illustrates a graphical user interface (GUI) displaying graphical representations of different workspaces accessible to a user for review and management, in accordance with some example embodiments;

FIG. 15 illustrates a GUI displaying different graphical representations of users and the corresponding workspaces of which they have been or are participants, in accordance with some example embodiments;

FIG. 16 illustrates a GUI displaying a graphical representation of a timeline of a workspace, in accordance with some example embodiments;

FIG. 17 is a flowchart illustrating a method, in accordance with some embodiments, of integrating different collaboration modes in a single workspace;

FIG. 18 is a block diagram illustrating a mobile device, in accordance with some example embodiments; and

FIG. 19 is a block diagram of an example computer system on which methodologies described herein can be executed, in accordance with some example embodiments.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Example systems and methods of integrating collaboration modes are disclosed. In the following description, for purposes of explanation, numerous specific details are set forth in order to provide a thorough understanding of example embodiments. It will be evident, however, to one skilled in the art that the present embodiments can be practiced without these specific details.

In some example embodiments, a computer-implemented method comprises receiving a first indication of a first synchronous collaboration event for a first workspace, and storing a first record of the first synchronous collaboration event in association with the first workspace based on the first indication. The first record comprises first participant data indicating a first participant of the first synchronous collaboration event, first content data indicating content provided by the first participant during the first synchronous collaboration event, and first temporal data indicating a first time of occurrence of the first synchronous collaboration event. A second indication of a second asynchronous collaboration event for the first workspace is received, and a second record of the second asynchronous collaboration event is stored in association with the first workspace based on the second indication. The second record comprises second participant data indicating a second participant of the second asynchronous collaboration event, second content data indicating content provided by the second participant during the second asynchronous collaboration event, and second temporal data indicating a second time of occurrence of the second asynchronous collaboration event. A first timeline for the first workspace is caused to be displayed on a computing device. The first timeline comprises a first graphical representation of the first synchronous collaboration event based on the first record and a second graphical representation of the second asynchronous collaboration event based on the second record.

In some example embodiments, a workspace object model hierarchy is provided that encompasses synchronous collaboration as a conference and its incorporated sessions such that the content, participants, and interactions of a synchronous collaboration can be stored and accessed as referenceabe shared objects in a corresponding workspace. The workspace object model hierarchy can also provide workspace object relationships such that specific shared content objects can be associated with either conferences or sessions, as well as with each other.

In some example embodiments, a workspace object corresponding to the first workspace is generated based on a workspace object model, and storing the first record comprises storing the first synchronous collaboration event, the first participant data, and the first content data as shared objects of the workspace object, enabling users that are identified as participants of the first workspace to access and use the first synchronous collaboration event, the first participant data, and the first content data as content within a context of the first workspace.

In some example embodiments, using the first synchronous collaboration event, the first participant data, and the first content data as content within the context of the first workspace comprises submitting comments to be stored in association with a corresponding one of the synchronous collaboration event, the first participant data, and the first content data, the comments being stored as shared objects of the first workspace.

In some example embodiments, the workspace object model is configured to enable any shared objects of the first workspace to be associated with any other shared objects of the first workspace.

In some example embodiments, a timeline event model provides timeline semantics (e.g., a specified actor acting in the context of a specified workspace performed a specified action on or with respect to a specified workspace object at a specified time or between a specified start time and a specified end time). The timeline event model can be applied to both synchronous and asynchronous events in a single seamlessly interleaved temporal context, and it can enable a range of timeline views to be extracted based, for example, on a participant, a shared object, or a type of action, as well as other criteria.

In some example embodiments, storing the first record of the first synchronous collaboration event comprises generating and storing a first timeline event object based on a timeline event model, the first timeline event object being stored in association with the first workspace as part of the first record, and storing the second record of the first asynchronous collaboration event comprises generating and storing a second timeline event object based on the timeline event model, the second timeline event object being stored in association with the first workspace as part of the second record. The timeline event model can be configured to provide semantics for the first timeline event object and the second timeline event object, the semantics enabling a specification of a specific actor in a specific context of a specific workspace performed a specific action with respect to a specific workspace object at a specific time.

In some example embodiments, the timeline event model is further configured to enable a view of the first timeline to be presented based on a specification of one or more elements of the semantics by a user.

In some example embodiments, an actor model is configured to distinguish between a user in a broad platform and a participant in a specific workspace, with the participant being allowed to perform certain operations within or with respect to the workspace, and the user in the broad platform being prevented or otherwise restricted from performing those certain operations within or with respect to the workspace. The actor model can also be configured to enable the inclusion in a workspace and workspace timeline of non-human actors (e.g., assets, workflows).

In some example embodiments, storing the first record comprises generating and storing a first actor object based on an actor model, the first actor object comprising the first participant data and being stored in association with the first workspace as part of the first record, and storing the second record comprises generating and storing a second actor object based on the actor model; the second actor object comprising the second participant data and being stored in association with the first workspace as part of the first record. The actor model can be configured to enable a distinction to be made between an actor being a general user of a platform and the actor being a participant of a specific workspace, the distinction being used to define a role for the actor, the role being used to determine what actions the actor is permitted to perform with respect to a workspace.

In some example embodiments, the actor model is further configured to enable a specification of a non-human actor for a corresponding actor object. Such non-human actors can include, but are not limited to, assets (e.g., equipment, such as a turbine) and workflows (e.g., one or more electronically-implemented process steps, which can be performed in response to an external event).

In some example embodiments, the content provided by the first participant during the first synchronous collaboration event comprises one of text from an online chat-based session event, a document uploaded by the first participant, audio from an audio-based session event, and video from a video-based session event.

In some example embodiments, the content provided by the second participant during the second asynchronous collaboration event comprises one of text, a document, audio, and video.

In some example embodiments, the first participant of the first synchronous collaboration event is different from the second participant of the second synchronous collaboration event.

In some example embodiments, a third indication of a third synchronous collaboration event for the first workspace is received, and a third record of the third synchronous collaboration event is stored in association with the first workspace based on the third indication, with the third record comprising third participant data indicating a third participant of the third synchronous collaboration event, third content data indicating content provided by the third participant during the third synchronous collaboration event, and third temporal data indicating a third time of occurrence of the third synchronous collaboration event, and the first timeline further comprising a third graphical representation of the third synchronous collaboration event based on the third record.

In some example embodiments, a third indication of a third asynchronous collaboration event for the first workspace is received, and a third record of the third asynchronous collaboration event is stored in association with the first workspace based on the third indication, with the third record comprising third participant data indicating a third participant of the third asynchronous collaboration event, third content data indicating content provided by the third participant during the third asynchronous collaboration event, and third temporal data indicating a third time of occurrence of the third asynchronous collaboration event, and the first timeline further comprising a third graphical representation of the third asynchronous collaboration event based on the third record.

In some example embodiments, a corresponding record for each of a plurality of synchronous collaboration events and asynchronous collaboration events is stored in association with a second workspace, with each corresponding record comprising corresponding participant data indicating a corresponding participant of the corresponding collaboration event, corresponding content data indicating corresponding content provided by the corresponding participant during the corresponding collaboration event, and corresponding temporal data indicating a corresponding time of occurrence of the corresponding collaboration event, and a second timeline for the second workspace is caused to be displayed on the computing device, with the second timeline comprising a corresponding graphical representation for each of the plurality of synchronous collaboration events and asynchronous collaboration events based on their corresponding records.

In some example embodiments, an identification of a second user different from a first user is received from the first user on the computing device, and a list of workspaces for which the second user has been a participant is generated based on the identification of the second user, and the list of workspaces is caused to be displayed to the first user on the computing device.

Alternative embodiments other than the embodiments discussed above are also within the scope of the present disclosure, some examples of which are also provided in the present disclosure.

Some technical effects of the system and method of the present disclosure are to provide a workspace designed around a temporal organization with unified state and content models, and to enable the creation of unified workspaces that incorporate both synchronous and asynchronous collaboration modalities in a seamless fashion. Additionally, other technical effects will be apparent from this disclosure as well.

The methods or embodiments disclosed herein may be implemented as a computer system having one or more modules (e.g., hardware modules or software modules). Such modules may be executed by one or more processors of the computer system. In some embodiments, a non-transitory machine-readable storage device can store a set of instructions that, when executed by at least one processor, causes the at least one processor to perform the operations and method steps discussed within the present disclosure.

In the description below, for purposes of explanation only, specific nomenclature is set forth to provide a thorough understanding of the present disclosure. However, it will be apparent to one skilled in the art that these specific details are not required to practice the teachings of the present disclosure.

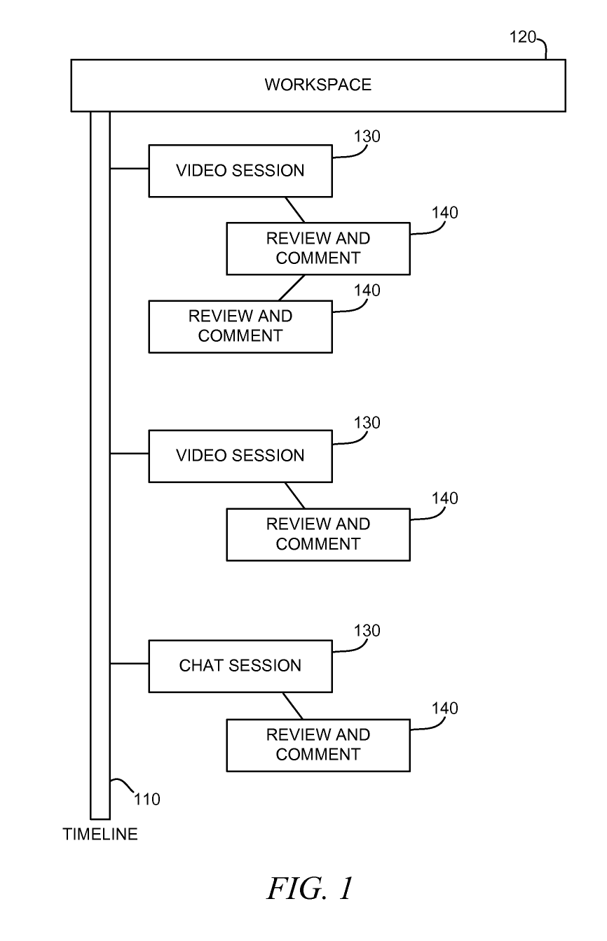

FIG. 1 is a conceptual diagram illustrating a timeline 110 for a workspace 120 that includes synchronous collaboration events 130 and asynchronous collaboration events 140, in accordance with some example embodiments. The workspace 120 comprises a shared context within which content can be shared, annotated, commented, and otherwise provided, worked on, and managed by multiple participants of the workspace 120 over time. The synchronous collaboration events 130 and the asynchronous collaboration events 140 comprise the content that can be provided, worked on, and managed by the participants.

In some example embodiments, the synchronous collaboration events 130 comprise events that occur during real-time interactions (e.g., conferences) between participants. Examples of such real-time interactions include, but are not limited to, videoconference sessions, videophone call sessions, audio phone call sessions, online chat sessions (e.g., instant messaging sessions, Internet relay chat sessions, talker sessions, multi-user domain sessions), web conferencing sessions, desktop sharing sessions, and sessions that include features from one or more of these enumerated examples of sessions.

In some example embodiments, the asynchronous collaboration events 140 comprise events that occur during non-real-time interactions. Examples of such non-real-time interactions include, but are not limited to, transmitting of messages (e.g., e-mails, comments), uploading of documents or other files, and editing of documents or other files.

The synchronous collaboration events 130 and asynchronous collaboration events 140 can comprise content contributed by, provided by, or otherwise associated with, the participants of the workspace 120. Examples of such content can include, but are not limited to, an audio recording of a conference session, a video recording of a conference session, a text-based transcript of a conference session, a text-based transcript of an online chat session, an e-mail, a comment, a document, and other files.

As seen in FIG. 1, the timeline 110 can comprise a list of the events 130 and 140 in chronological order. Collaboration events 130 and 140 can branch off of one another, thereby forming a thread of collaboration events. For example, a video conference session can be conducted as part of the workspace 120. Subsequently, one of the participants of the workspace 120 can review the video conference session and provide corresponding comments. Another participant can subsequently review the video conference session and/or the other participant's comments, and then provide his or her own corresponding comments. Other examples are also within the scope of the present disclosure.

Asynchronous workspaces in known solutions are stateless. The state of individual entities is neither correlated across the workspace, nor aggregated at the workspace level. They are essentially bags of content with shared access. On the other hand, synchronous collaboration events, such as conferences, are highly stateful, and the state of individual interaction modalities is highly correlated at the conference level. One aspect of this correlation is that conferences have a strong temporal organization and frequently provide tight time synchronization between interaction modalities. Conferences are highly time bound, and the duration of a conference is generally very limited. Synchronous collaboration tools can also be tightly coupled to a synchronous infrastructure 240, such as presence servers, audio/video processing systems, and communications infrastructure.

In existing conference systems, individual conferences are considered to be transient constructs, essentially lasting for the duration of a single synchronous session. The conference details that are retained are limited to what is necessary for billing and auditing, although conference artifacts are sometimes preserved. These artifacts can include chat transcripts, and audio/video recordings. However, these artifacts are fetched and saved by users outside the conference context. Therefore, little or no consideration is given to making such conferences and conference artifacts deeply searchable, or putting them in a unified context. This is because existing workspaces have no temporal organization, and no unifying state and content models.

The present disclosure provides a workspace designed around a temporal organization with unified state and content models, enabling the creation of unified workspaces that incorporate both synchronous and asynchronous collaboration modalities in a seamless fashion.

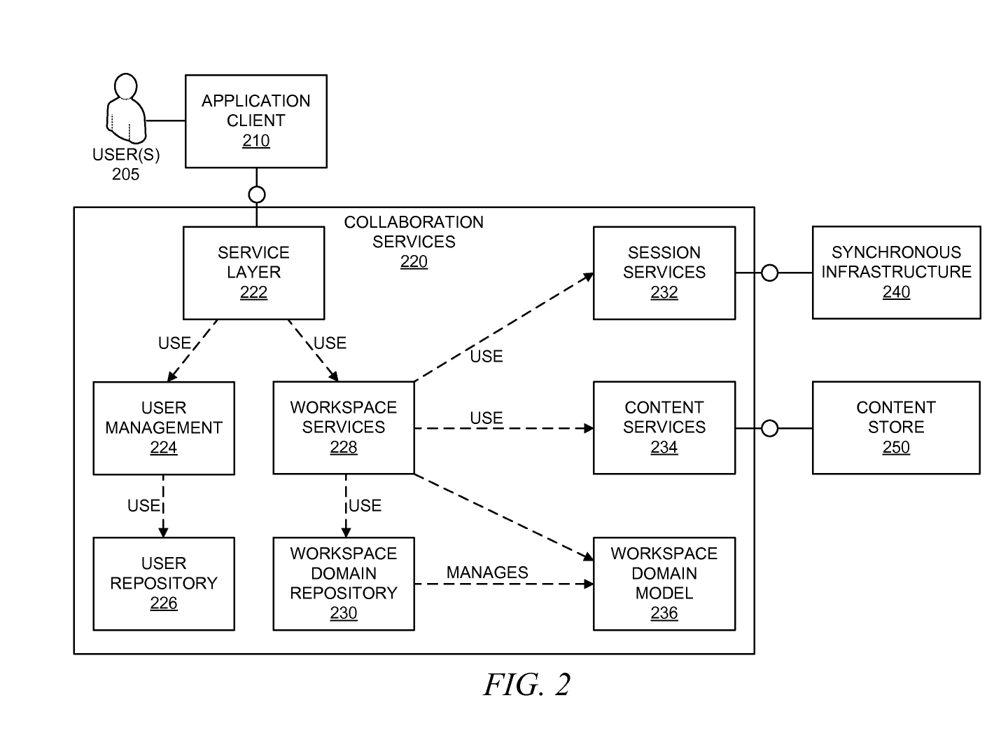

These features can be achieved via an organization of a domain model, as well as how it is utilized to provide a set of workspace services. These elements can be consumed within the context of a collaboration services system. FIG. 2 is a block diagram illustrating a collaboration services system 220, in accordance with some example embodiments. In some example embodiments, the collaboration services system 220 comprises any combination of one or more of a service layer module 222, a user management module 224, a user repository 226, a workspace services system 228, a workspace domain repository 230, a session services module 232, a content services module 234, and a workspace domain model 236. These components of the collaboration services system 220 can be communicatively coupled to each other, and can reside on the same single machine having a memory and at least one processor (not shown), or can reside on separate distinct machines. One or more users 205 can use an application client 210 on a computing device to communicate with and access the functionality and features (e.g., request the performance of operations) of the collaboration services system 220. Examples of computing devices include, but are not limited to, desktop computers, laptop computers, tablet computers, smartphones, and other mobile devices. The collaboration services system 220 can also be communicatively coupled to a synchronous collaboration infrastructure 240, such as one or more synchronous collaboration tools or presence servers. The collaboration services system 220 can also be communicatively coupled to a content store 250 configured to store content (e.g., documents, media) referenced from a workspace.

The communication (e.g., transmission) of data between systems, platforms, modules, databases, users, devices, and machines disclosed herein can be achieved via communication over one or more networks. Accordingly, the collaboration services system 220 can be part of a network-based system. The network may be any network that enables communication between or among systems, modules, databases, devices, and machines. Accordingly, the network may be a wired network, a wireless network (e.g., a mobile or cellular network), or any suitable combination thereof. The network may include one or more portions that constitute a private network, a public network (e.g., the Internet), or any suitable combination thereof.

The services and functions of the collaboration services system 220 can be accessed in integrated form by the service layer module 222, which can provide services to one or more of the external application clients 210, such as via a network service protocol such as Simple Object Access Protocol (SOAP) or Representational State Transfer (REST). In some example embodiments, the service layer module 222 functions as an interface layer between the application client 210 and the user management module 224 and the workspace services system 228. The user management module 224 can be configured to manage users of the collaboration services system 220, such as by managing user profiles or accounts. Such user profile or account information, as well as the results of management actions performed with respect to the user profiles or accounts, can be stored in the user repository 226.

In some example embodiments, the workspace services system 228 is configured to create and manage unified workspaces 120 that incorporate both synchronous collaboration events 130 and asynchronous collaboration events 140, as will be discussed in further detail below. Records of the synchronous collaboration events 130 and the asynchronous collaboration events 140 for workspaces 120, as well as their corresponding information (e.g., entities, attributes, roles, relationships, status), can be stored in the workspace domain repository 230. In some example embodiments, the workspace domain model 236 comprises a model of the various entities, their attributes, roles, and relationships, plus the constraints that govern the workspace domain.

The workspace domain model 236 can be accessed via the workspace repository 230 by the workspace services system 228. In addition to operating on the workspace domain model 236, the workspace services system 228 can also interact with the session services module 232, which can manage an external synchronous collaboration infrastructure 240. The synchronous collaboration infrastructure 240 can include, but is not limited to, audio/video processing elements, call routing elements, presence/chat elements, and other such synchronous collaboration elements. In some example embodiments, the session services module 232 is configured to communicate with the synchronous collaboration infrastructure 240 to conduct synchronous collaboration events 130 and/or to retrieve information corresponding to synchronous collaboration events 130 (e.g., participants, time of event, content of event) for use by the workspace services system 228.

The workspace services system 228 can also interact with the content services module 234, which can manage an external content storage infrastructure, such the content store 250 (e.g., a content management system). In some example embodiments, the content services module 234 is configured to communicate with the content store 250 to conduct asynchronous collaboration events 140 and/or to retrieve information corresponding to asynchronous collaboration events 140 (e.g., participants, time of event, content of event) for use by the workspace services system 228.

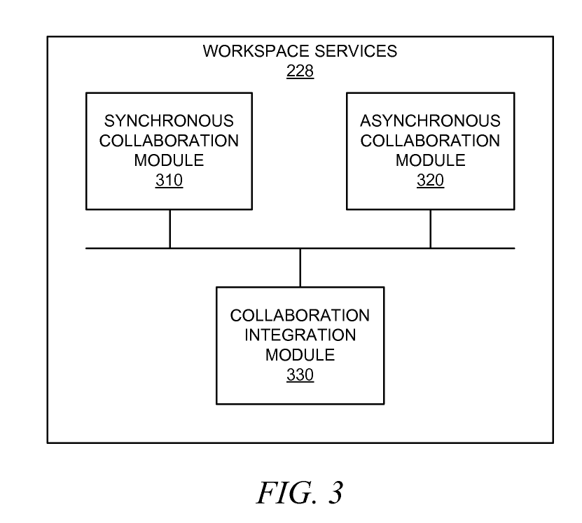

FIG. 3 is a block diagram illustrating components of the workspace services system 228, in accordance with some example embodiments. In some example embodiments, the workspace services system 228 comprises any combination of one or more of a synchronous collaboration module 310, an asynchronous collaboration module 320, and a collaboration integration module.

The synchronous collaboration module 310, the asynchronous collaboration module 320, and the collaboration integration module 330 can be communicatively coupled to each other, and can reside on the same single machine having a memory and at least one processor (not shown), or can reside on separate distinct machines.

In some example embodiments, the synchronous collaboration module 310 is configured to receive indications of synchronous collaboration events 130 for a workspace 120, and to store corresponding records of the synchronous collaboration events 130 in association with the workspace 120 based on the corresponding indications. Each record can comprise corresponding participant data indicating the one or more participants of the corresponding synchronous collaboration event 130 (e.g., identifications of each participant of a conference call or an online chat session), corresponding content data indicating content provided by the participant(s) during the corresponding synchronous collaboration event 130, and corresponding temporal data indicating a time of occurrence of the corresponding synchronous collaboration event 130 (e.g., date of the event, time of day of the event, time period of the event).

In some example, embodiments, the asynchronous collaboration module 320 is configured to receive indications of asynchronous collaboration events 140 for a workspace 120, and to store corresponding records of the asynchronous collaboration events 140 in association with the workspace 120 based on the corresponding indications. Each record can comprise corresponding participant data indicating the one or more participants of the corresponding asynchronous collaboration event 140 (e.g., identifications of each participant of an e-mail), corresponding content data indicating content provided by the participant(s) during the corresponding asynchronous collaboration event 140, and corresponding temporal data indicating a time of occurrence of the corresponding asynchronous collaboration event 140 (e.g., date of the event, time of day of the event, time period of the event).

In some example embodiments, the collaboration integration module 330 is configured to generate a corresponding timeline 110 for a workspace 120, and to cause the corresponding timeline 110 to be displayed on a computing device. Each timeline 110 can comprise a corresponding graphical representation for each synchronous collaboration event 130 and asynchronous collaboration event 140 and can be generated based on their corresponding records.

In some example embodiments, the content provided by the participant(s) during the synchronous collaboration events 130 comprises text from an online chat-based session event, a document uploaded by the first participant, audio from an audio-based session event, or video from a video-based session event. Other types of content are also within the scope of the present disclosure.

In some example embodiments, the content provided by the participant(s) during the asynchronous collaboration event 140 comprises one of text, a document, audio, and video. Other types of content are also within the scope of the present disclosure.

In some example embodiments, there can be at least one different participant between one synchronous collaboration event 130 and another synchronous collaboration event 130 of the same workspace 120, between one asynchronous collaboration event 140 and another asynchronous collaboration event 140 of the same workspace 120, or between a synchronous collaboration event 130 and an asynchronous collaboration event 140 of the same workspace 120.

In some example embodiments, the workspace services system 218 can be configured to create and manage multiple different workspaces 120 and their corresponding timelines 110. In some example embodiments, the collaboration integration module 330 is further configured to receive an identification of a user 205 from a computing device, generate a list of workspaces for which the identified user 205 has been a participant based on the identification of the user 205, and cause the list of workspaces to be displayed on the computing device. The identification of the user 205 can be provided by another user 205 different from the identified user 205 or can be provided by the same user 205.

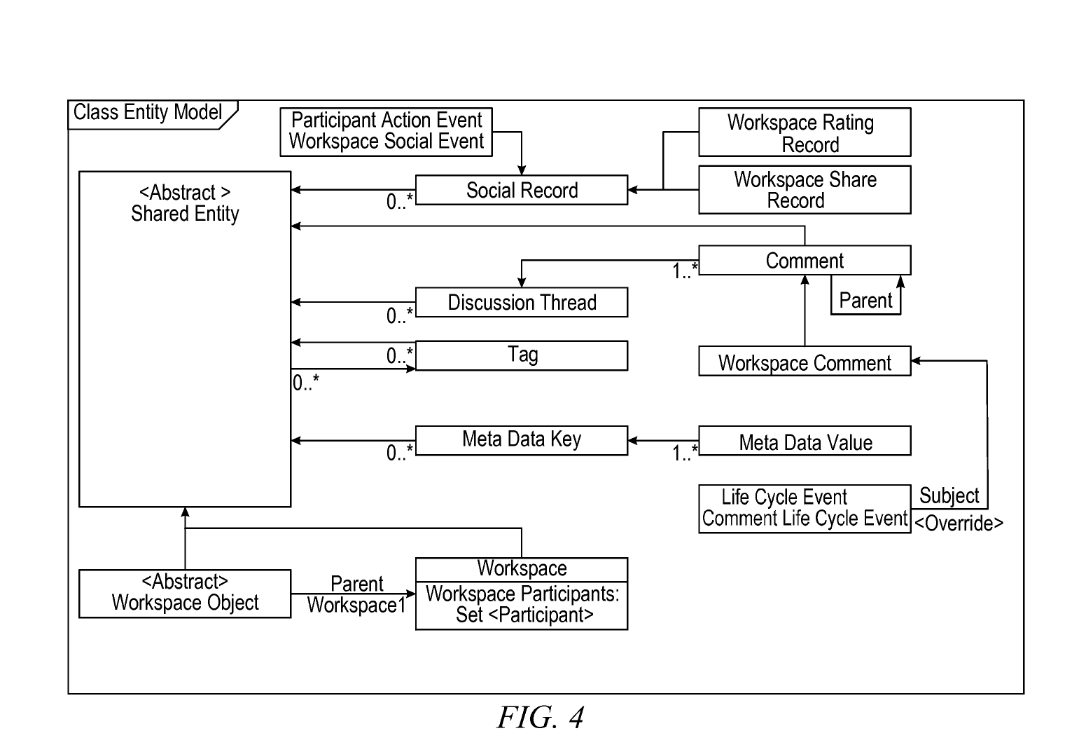

FIG. 4 is a unified modeling language (UML) class diagram for an entity model, in accordance with some example embodiments. In some example embodiments, the entity model defines a top-level entity SharedEntity. The SharedEntity can enable all major information artifacts related to the collaboration events, as well as the collaboration services system 220, to share a common base class that provides to all such artifacts a common set of social and search capabilities (e.g., share, rating, discussion threads/comments, tags, and metadata). Two child entities of SharedEntity can be defined: the Workspace, and the WorkspaceObject.

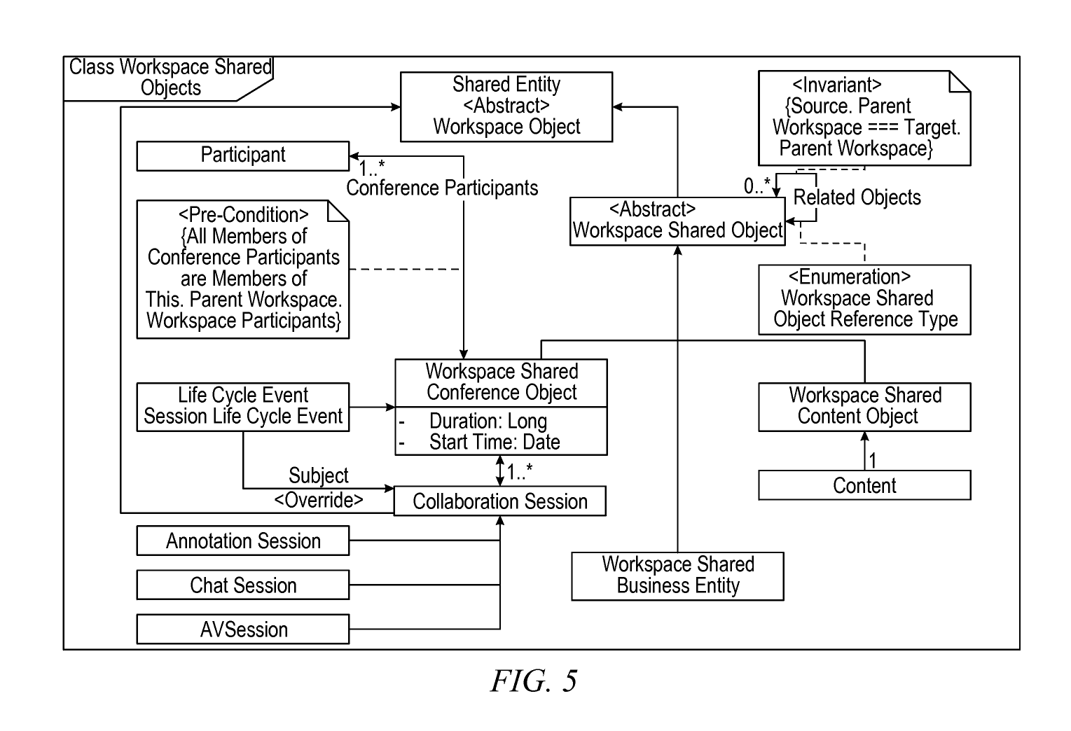

FIG. 5 is a UML class diagram for a workspace shared object (WorkspaceSharedObject), in accordance with some example embodiments. In some example embodiments, the inheritance chain of the WorkspaceSharedObject is BasicEntity:WorkspaceObject:WorkspaceSharedObject. In this way, all children of WorkspaceSharedObject inherit the social and search features of its parents. The WorkspaceSharedObject can model all of the content, whether static or dynamic, real-time or non-real-time, which is available to Participants in the context of a workspace.

In some example embodiments, the set of WorkspaceSharedObjects in this design is split into two subclasses: WorkspaceSharedContentObject and WorkspaceSharedSessionObject, which can model asynchronous and synchronous shared artifacts respectively. In this way, the features of the present disclosure provide a single high-level construct for both types of artifacts. In some example embodiments, the WorkspaceSharedContentObject wraps a Content entity, which itself can model any form of static content, whether hosted locally are remotely. Examples of such static content include, but are not limited to, documents such as pdf, word, and text files, and media such as images (e.g., jpeg, gif, tif files) and audio/video files (e.g., .mp4, .mov files). In some example embodiments, the Content entity is not exclusive to the WorkspaceSharedContentObject, but rather may be referenced by other entities in the collaboration services system 220 and referenced from within multiple Workspaces or even multiple times within the same Workspace.

In some example embodiments, the WorkspaceSharedConferenceObject has an ownership relationship with one or many CollaborationSession entities. This is because Conferences can be started by the WorkspaceServices Component within the context of a specific Workspace and, as shown in the diagram, Participants in a conference can be constrained to the set of Participants bound to that Workspace. By encompassing a multiplicity of CollaborationSession entities, the WorkspaceSharedConferenceObject effectively models a complex conference in which multiple sessions of multiple communication modalities are employed in a synchronized manner. In some example embodiments, CollaborationSession entities are of multiple types, including, but not limited to, ChatSession, AVSession, and AnnotationSession.

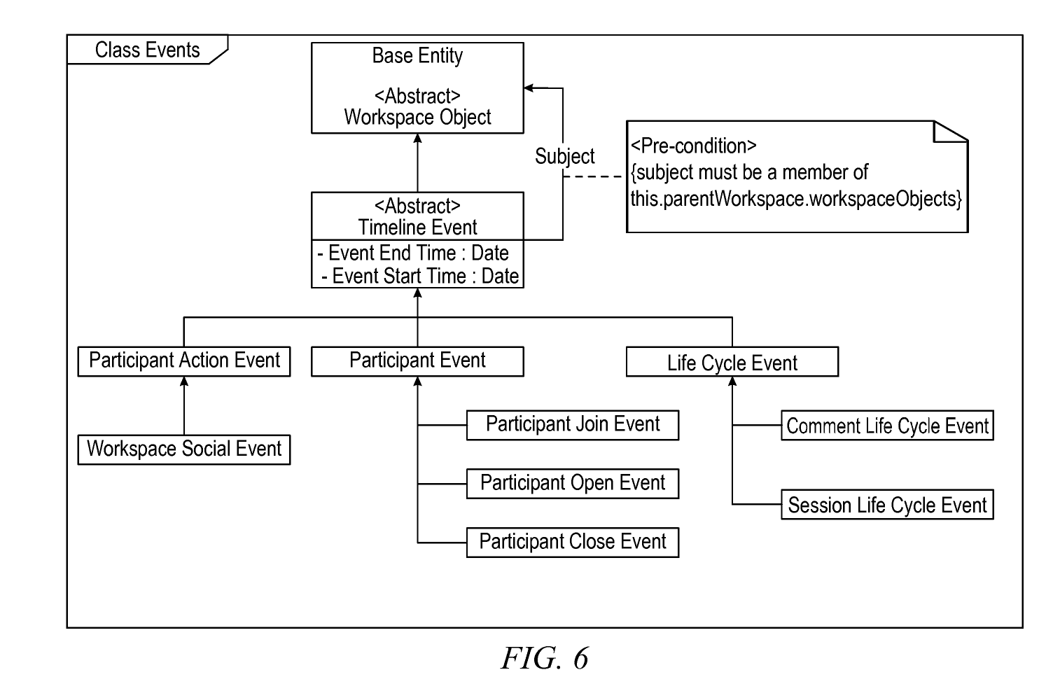

FIG. 6 is a UML class diagram for an event, in accordance with some example embodiments. The temporal organization and unified state aspects of the present disclosure can be further understood by first considering the domain Event model as partially elucidated in FIG. 6, which defines a top level TimeLineEvent from which all other Events in the model derive. TimeLineEvent can be a WorkspaceObject, and, therefore, all derived Events can have the full set of Social and Search attributes which are carried in the BaseEntity. Beyond that, the essential semantics of a TimeLineEvent can be based on five characteristics that can be specified for each instance of a TimeLineEvent. First, each such instance can belong uniquely to a single Workspace. Second, each such instance can specify a generator, which can be an instance of type Actor. Third, each such instance can specify a subject, which can be an instance of type WorkSpaceObject. The subject of the TimeLineEvent instance can be constrained to belong to the same Workspace as the event itself. Fourth, each such instance can carry a start and end time. The start time provides the time at which the event occurred, and the end time, for events which are not instantaneous, the time when it ended. Finally, each specific subclass of TimeLineEvent can specify a specific action that is modeled by the specific event instance. In sum, then, the semantics of TimeLineEvents can form sentences of the form: This Actor, acting in the context of this Workspace, took this action on, or with respect to, this WorkSpaceObject at this time, or between this start time and this end time.

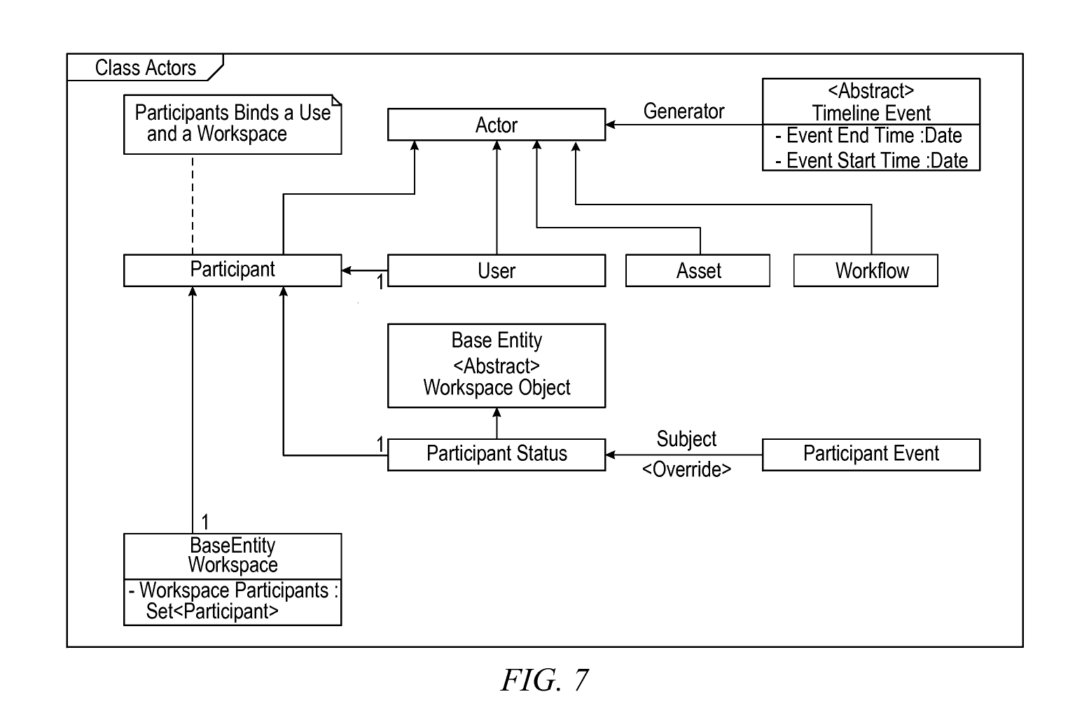

FIG. 7 is a UML class diagram for an actor, in accordance with some example embodiments. FIG. 7 illustrates the structure and semantics of the Workspace and Actor entities, in accordance with some example embodiments. As shown here, and as previously referenced, an Actor entity can be identified as the generator of a TimeLineEvent instance. Semantically, Actors can represent real world entities that exist independent of the collaboration services system 220. In some example embodiments, Actors can be of two main types, Users that are human users known to, and allowed to act on, the collaboration services system 220 containing, and Assets that represent physical entities that are of interest to the collaboration services system 220, but are typically not human. Assets can serve as sources of data into the collaboration services system 220, and can represent a point of integration with an active industrial environment. Other non-human actors can include, but are not limited to, workflows. A workflow can comprise one or more electronically-implemented process steps, which can be performed in response to an external event. The workflow can perform an action with respect to a workspace, thereby updating the workspace.

One additional subclass of Actor is the Participant entity, which can serve as a bridge between the User and the Workspace. As shown in FIG. 7, each Participant instance can be associated with a single User instance and a single Workspace instance. Semantically, then, the Participant can represent a User in the context of a Workspace. Each Participant instance can contain a ParticipantStatus that is a WorkspaceObject. The ParticipantStatus can contain the presence status of the Participant in the Workspace (e.g., idle or active), and can serve as the subject of the ParticipantEvent subclass of TimeLineEvent. ParticipantEvents can capture the status changes of the Participant with respect to the Workspace over time.

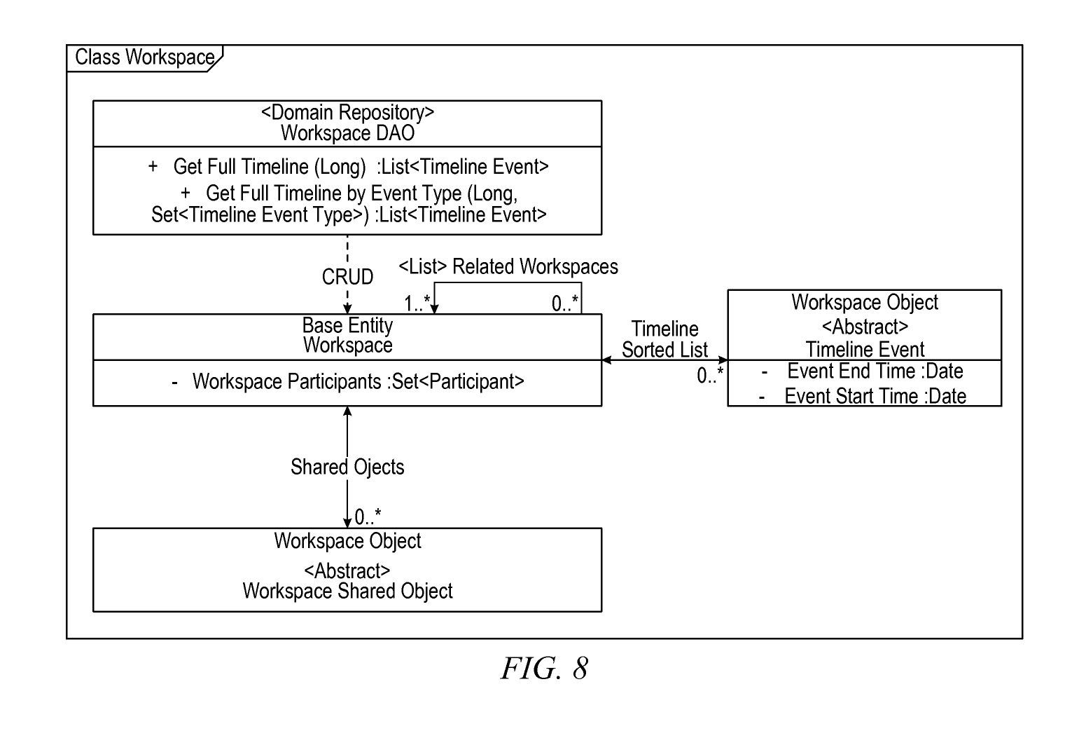

FIG. 8 is a UML class diagram for a workspace, in accordance with some example embodiments. FIG. 8 shows a design for a Workspace entity. As has been described previously, the Workspace entity can be derived from BaseEntity, and can therefore be a fully searchable and socialized entity. It can aggregate a set of references to other related Workspaces in order to identify Workspace clusters and thereby support relevance based searching amongst Workspaces by the encapsulating collaboration services system 220. It can bind together a collection of Participants associated with the Workspace with a collection of WorkspaceSharedObjects shared in the context of the Workspace, and a collection of TimeLineEvents that have occurred in the context of the Workspace. As further shown in FIG. 8, in some example embodiments, the Timeline itself is not stored as a persistent Domain Entity, but is rather formed dynamically from the TimeLineEvents by the WorkspaceDAO, which is itself a part of the workspace services system 228. The WorkspaceDAO may provide a number of views into the Timeline by filtering and/or sorting by one or more characteristics of the TimeLineEvent such as by TimeLineEvent subclass type, eventStartTime, event subject, or event generator. In this way, the complete list of all TimeLineEvents owned by a Workspace can provide a rich and detailed temporal context for that Workspace, and combined with the list of Workspace Participants and Shared Objects, can provide a unified context with a strong temporal organization.

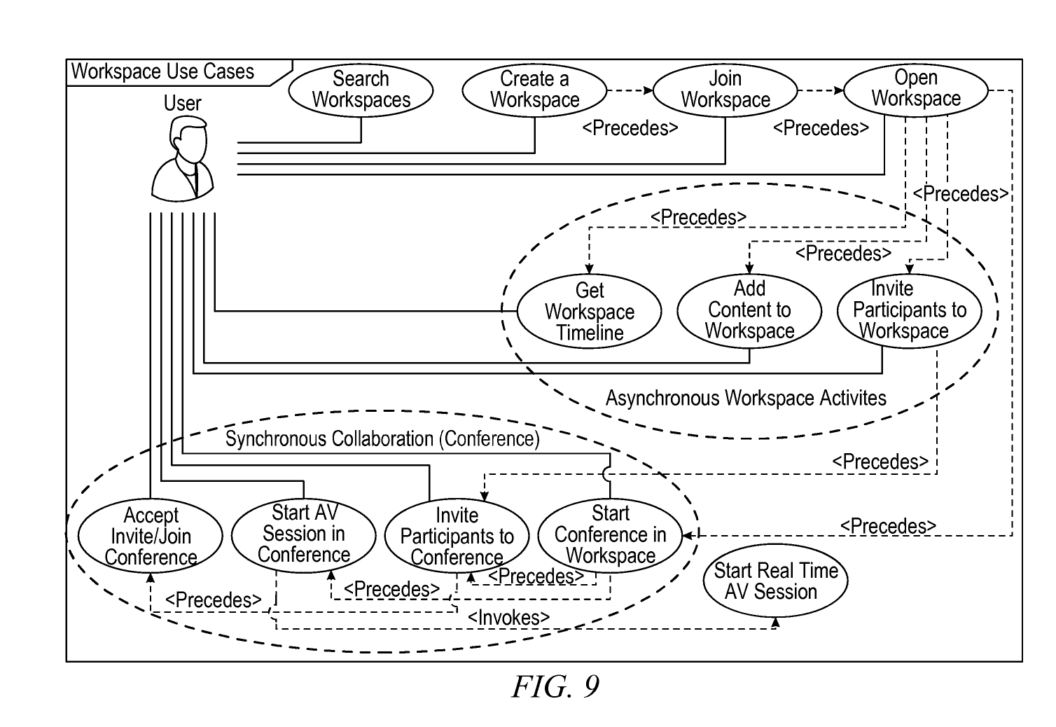

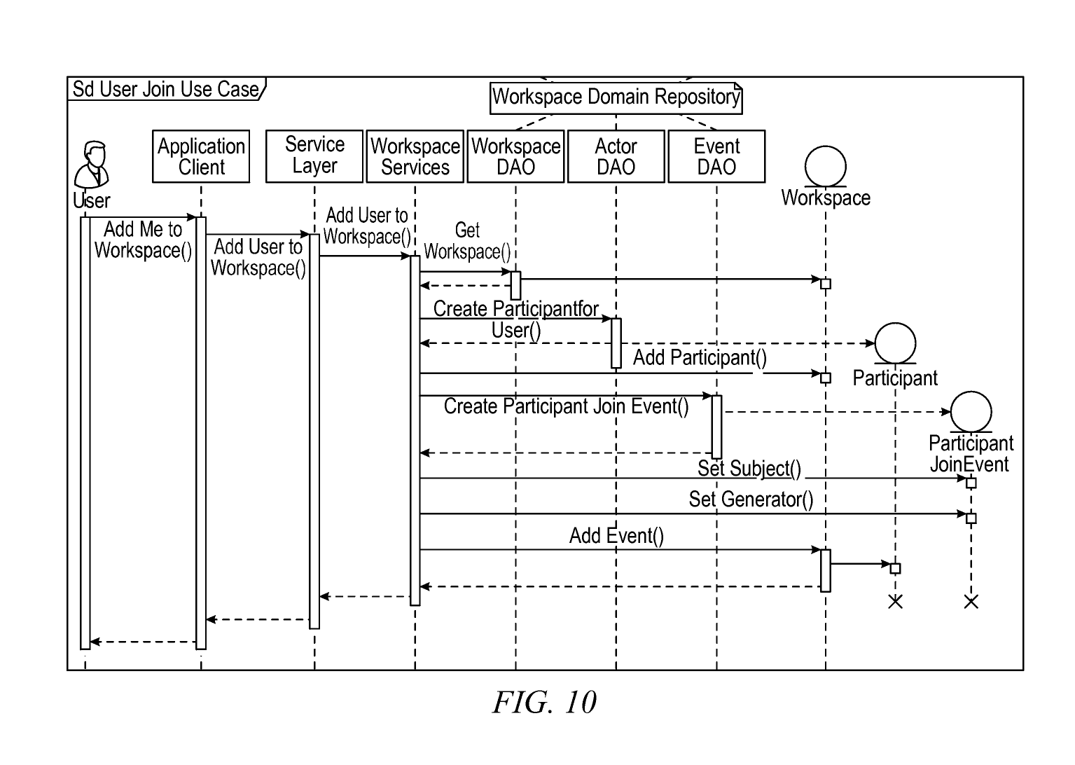

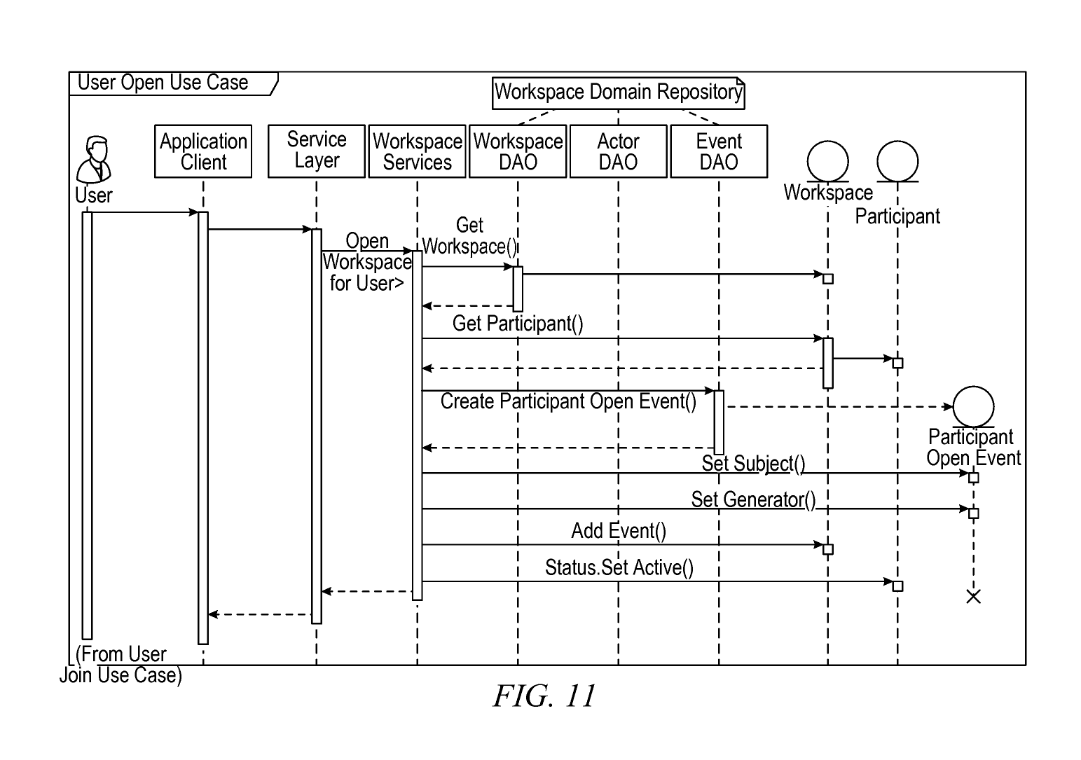

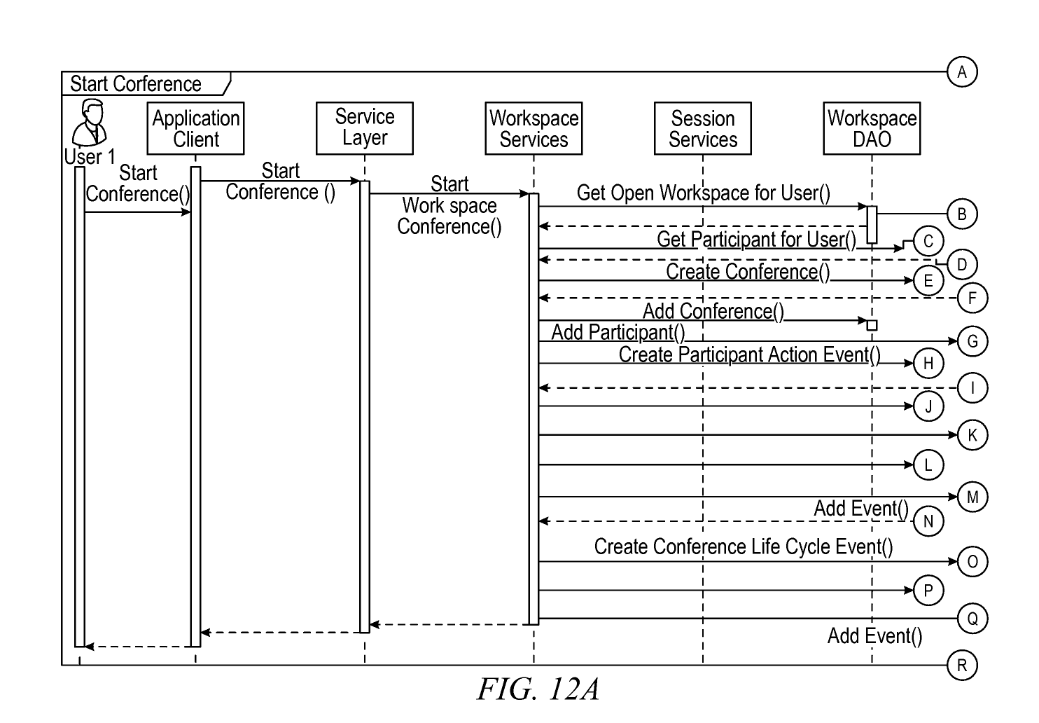

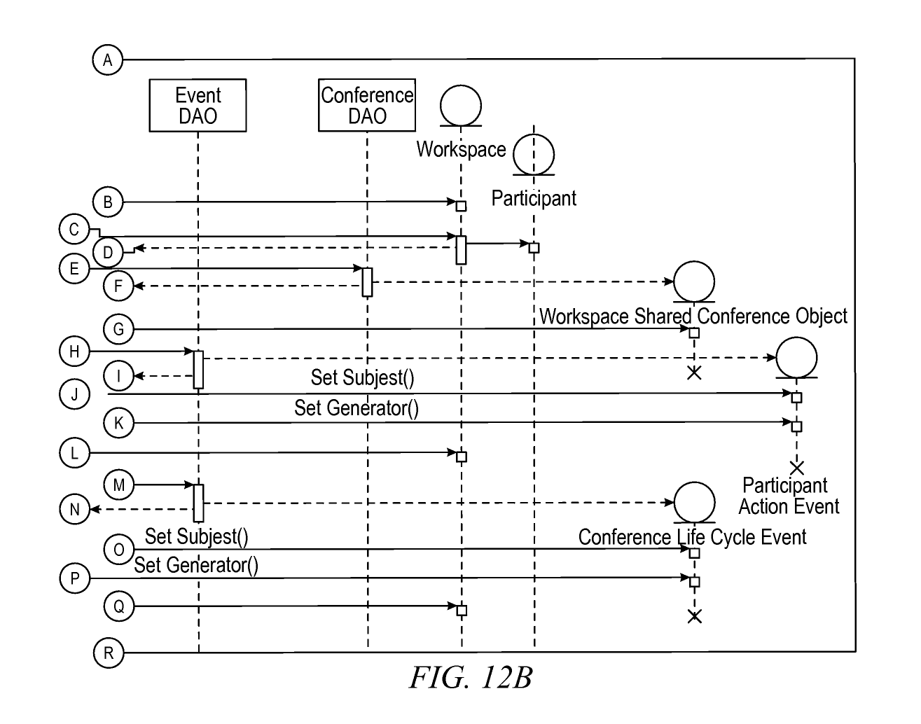

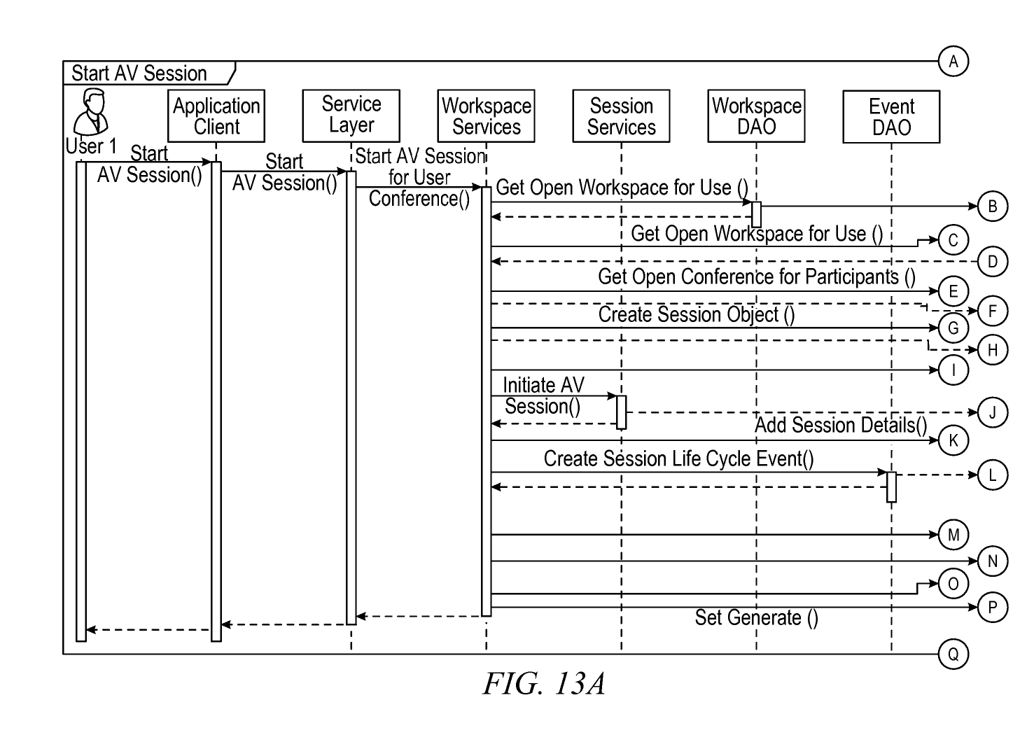

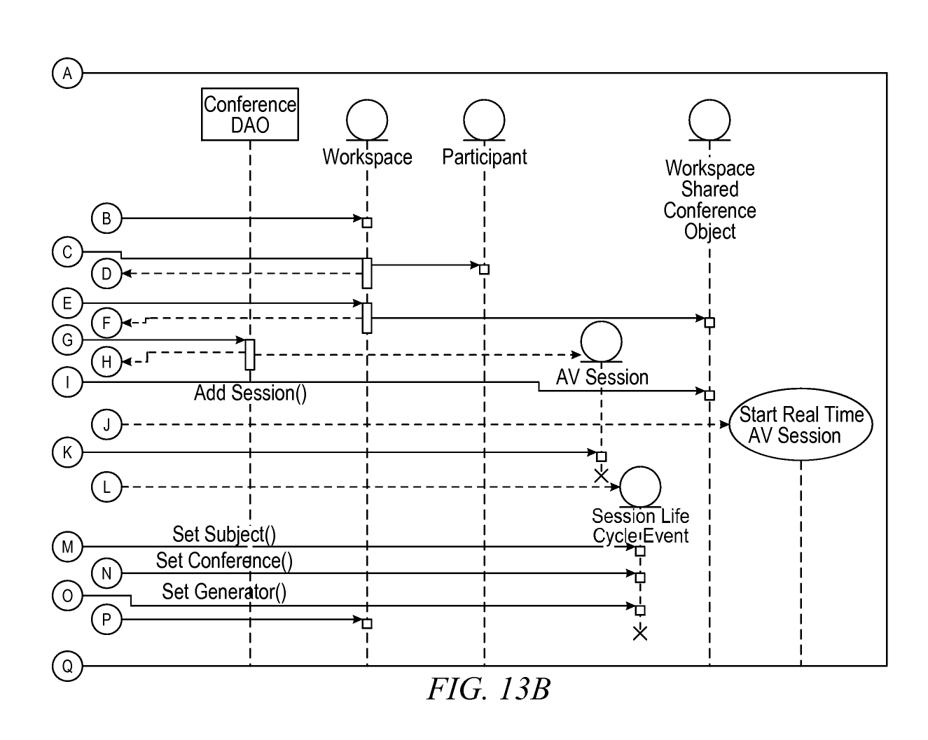

FIG. 9 is a diagram illustrating workspace use cases, in accordance with some example embodiments. For these workspace use cases, use case realizations are disclosed in the form of sequence diagrams. FIG. 10 is a sequence diagram for a user joining a workspace, in accordance with some example embodiments. FIG. 11 is a sequence diagram for a user opening a workspace, in accordance with some example embodiments. FIGS. 12A-12B illustrate a sequence diagram for a user starting a conference, in accordance with some example embodiments. FIGS. 13A-13B illustrate a sequence diagram for a user starting an audio/video (AV) session, in accordance with some example embodiments.

FIG. 9 shows how certain use cases work together to provide and support synchronous collaboration, whereas others work together to provide and support asynchronous collaboration and activities. In FIGS. 10-13B, the sequence diagrams illustrate how the application client 210, the service layer 222, the workspace services system 228, and the workspace domain repository 230 can be chained together in a sequence of calls to implement the desired user functionality.

As illustrated in FIG. 9, in some example embodiments, a workspace must exist before a user can join it, and the user must join it before the user can open it. In this way, the collaboration services system 220 can identify those participants with an ongoing relationship to a workspace and separately identify the presence status of that participant within the workspace.

As previously mentioned, FIG. 10 is a sequence diagram for a user joining a workspace, in accordance with some example embodiments. FIG. 10 illustrates one example of how a participant can be created and added to the workspace at the point where a user joins that workspace, and shows the creation and addition to the workspace of the relevant timeline events resulting from these user actions.

Referring back to FIG. 9, in some example embodiments, similar to the join and open use cases, the start conference use case can precede the start AV session use case. Additionally, the start AV session use case can invoke a start real-time session use case. The start real-time session can utilize resources external to the workspace itself, and thus is shown outside the set of collaborating synchronous collaboration use cases.

The start conference sequence of FIG. 12 shows how a WorkspaceSharedConferenceObject can created, configured and added to a workspace, in accordance with some example embodiments. It further shows the creation and addition to the workspace of two separate timeline events associated with this action. In some example embodiments, there is a ParticipantActionEvent and a ConferenceLifeCycleEvent capturing the significance of this action with respect to the participant and with respect to the conference, respectively. In this way, the development and expression of a rich temporal semantics can be enabled.

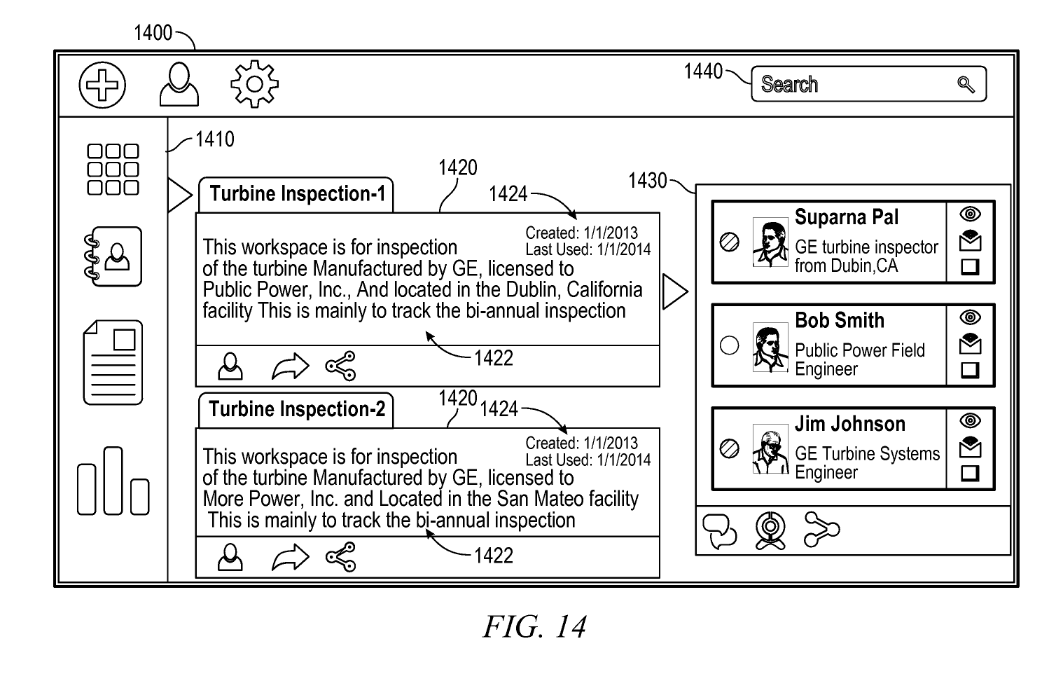

FIG. 14 illustrates a graphical user interface (GUI) 1400 displaying graphical representations of different workspaces 1420 (e.g., Turbine Inspection-1, Turbine Inspection-2) accessible to a user for review and management, in accordance with some example embodiments. The GUI 1400 can comprise a menu 1410 from which a user can select options for performing different tasks with respect to workspaces. In FIG. 14, the user has selected an option to view the graphical representations of workspaces 1420. In some example embodiments, the GUI 1400 can display only the graphical representations 1420 of workspaces of which the user is a participant, while in other example embodiments, the GUI 1400 can display graphical representations 1420 all workspaces in the collaboration services system 220.

In some example embodiments, each graphical representation of a workspace 1420 comprises a description 1422 of the workspace (e.g., the subject of the workspace) and temporal data 1424 of the workspace (e.g., when the workspace was created, when the workspace was last used). The user can select the graphical representation 1420 of a workspace to view a list of participants 1430 for that workspace. The GUI 1400 can also comprise a search field 1440 to enable the user to search for workspaces, participants, or collaboration events based on keywords provided by the user.

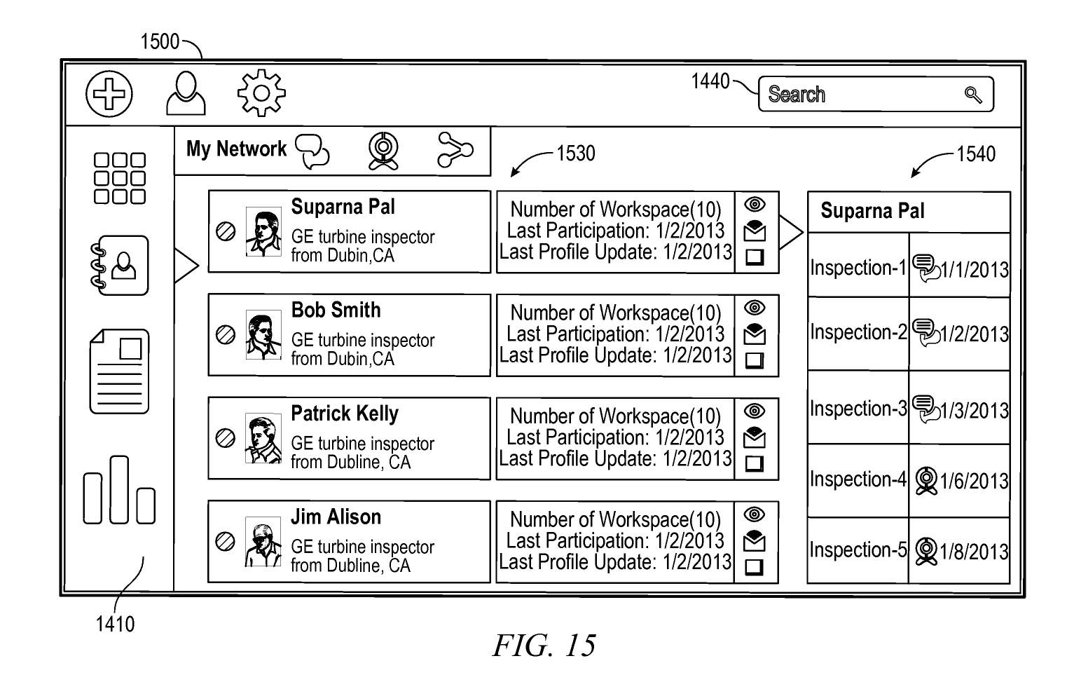

FIG. 15 illustrates a GUI 1500 displaying graphical representations of different users 1540 and the corresponding workspaces 1540 of which they have been participants or are currently participants, in accordance with some example embodiments. The GUI 1500 can display the graphical representations 1530 of different users that are part of a network of contacts for a user (e.g., for the user using the GUI 1500) in response to the user selecting a view network of contacts option from the menu 1410.

Each graphical representation 1530 of a user can comprise an identification of the corresponding user (e.g., name), profile information of the corresponding user (e.g., company/organization, position, location), an indication of how many workspaces of which the corresponding user is a participant, an indication of the last time (e.g., date) the corresponding user participated in a workspace, and an indication of the last time (e.g., date) the corresponding user updated his or her profile. Other configurations of the graphical representations 1530 are also within the scope of the present disclosure.

The GUI 1500 can display the graphical representations 1540 of the corresponding workspaces of which a user has been or currently is a participant in response to a selection of a corresponding graphical representation 1530 of that user (e.g., the selection of Suparna Pal can cause the display of al of the workspaces to which Suparna Pal has been a participant). The graphical representations 1540 of the corresponding workspaces can comprise an identification of each workspace (e.g., name), an indication of the last time (e.g., date) a modification was made to the workspace (e.g., the last time content was added to the workspace, removed from the workspace, or edited), and an indication of the type of the last modification (e.g., a comment, an AV session recording). The identification of a workspace can be configured to be selected by a user, causing the display of a graphical representation of a timeline of that workspace.

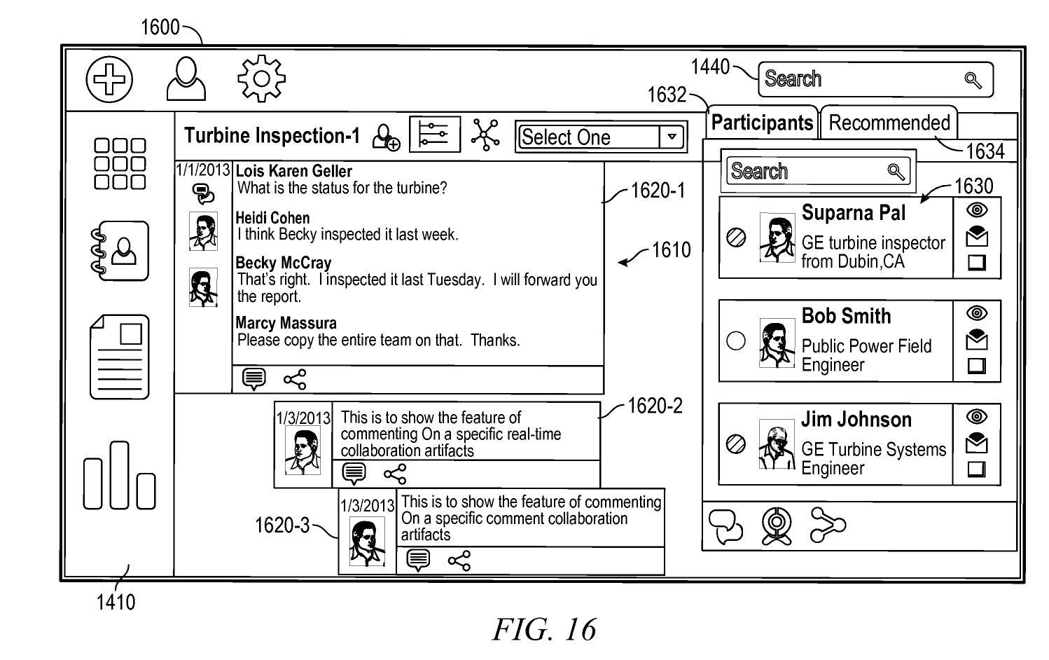

FIG. 16 illustrates a GUI 1600 displaying a graphical representation 1610 of a timeline for a workspace, in accordance with some example embodiments. The graphical representation 1610 of the timeline can comprise detailed graphical representations of collaboration events 1620-1 (e.g., text of an online chat), 1620-2 (e.g., a textual comment), and 1620-3 (e.g., a textual comment) of the workspace. The detailed graphical representations of the collaboration events 1620 can comprise an identification of each participant of the corresponding collaboration event (e.g., name, image), as well as temporal data of the corresponding collaboration event (e.g., date, time). Other configurations of the timeline 1610 and the graphical representations of the collaboration events 1620 are also within the scope of the present disclosure.

The GUI 1600 can also display a list of the participants 1630 of the corresponding workspace for which the graphical representation 1610 of the timeline is being displayed. The list of the participants 1630 can comprise an identification of each participant (e.g., name, image) and profile information of the corresponding participant (e.g., company/organization, position, location). The list of the participants 1630 can be displayed in response to a user selection of a selectable “Participants” tab 1632.

In some example embodiments, the workspace services system 228 is further configured to determine users to recommend as participants for the workspace for which the graphical representation of the timeline 1610 is being displayed. This determination can be based on an analysis of what other workspaces users have participated in, how closely those other workspaces are related to the current workspace being viewed, the level of participation by the users (e.g., frequency of contribution), and/or profile information of the users compared to the current workspace being viewed (e.g., does a user's job position correspond to the subject of the current workspace). Other configurations are also within the scope of the present disclosure.

The determined participants to recommend can then be displayed in the GUI 1600, such as in response to a user selection of a selectable “Recommended” tab 1634. The GUI 1600 can enable the user to add or invite one or more of the recommended participants to join the workspace, such as via the selection of a graphical user interface element. Other configurations are also within the scope of the present disclosure.

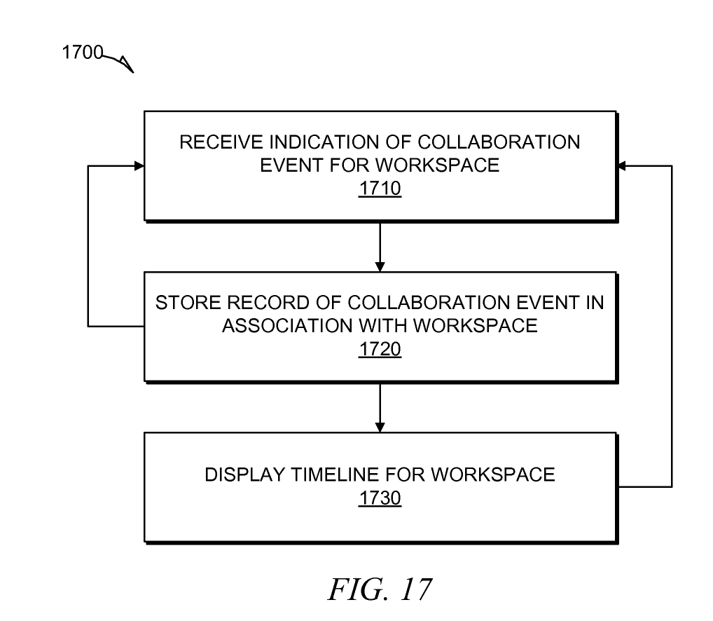

FIG. 17 is a flowchart illustrating a method, in accordance with some embodiments, of integrating different collaboration modes in a single workspace. Method 1700 can be performed by processing logic that can comprise hardware (e.g., circuitry, dedicated logic, programmable logic, microcode, etc.), software (e.g., instructions run on a processing device), or a combination thereof. In one implementation, the method 1700 is performed by the collaboration services system 220 of FIG. 2, or any combination of one or more of its components, as described above.

At operation 1710, an indication of a collaboration event for a workspace is received. The collaboration event can be a synchronous collaboration event or an asynchronous collaboration event, as previously discussed. At operation 1720, a record of the collaboration event is stored in association with the workspace based on the indication. The record can comprise participant data indicating the one or more participants of the collaboration event, content data indicating content provided by the participant(s) during the collaboration event, and temporal data indicating a time of occurrence of the collaboration event. Operations 1710 and 1720 can be repeated, with indications of collaboration events, synchronous and asynchronous, continuing to be received, and corresponding records being stored. At operation 1730, a timeline for the workspace is caused to be displayed on a computing device. The timeline can comprise graphical representations of the synchronous and asynchronous collaboration events based on their respective records. Operations 1710 and 1720 can be repeated, with indications of collaboration events, synchronous and asynchronous, continuing to be received, and corresponding records being stored. Users can perform operations (e.g., viewing details, editing details, searching) with respect to collaboration events, workspaces, participants of workspaces, and timelines. It is contemplated that any of the other features described within the present disclosure can be incorporated into method 1700.

### Example Mobile Device

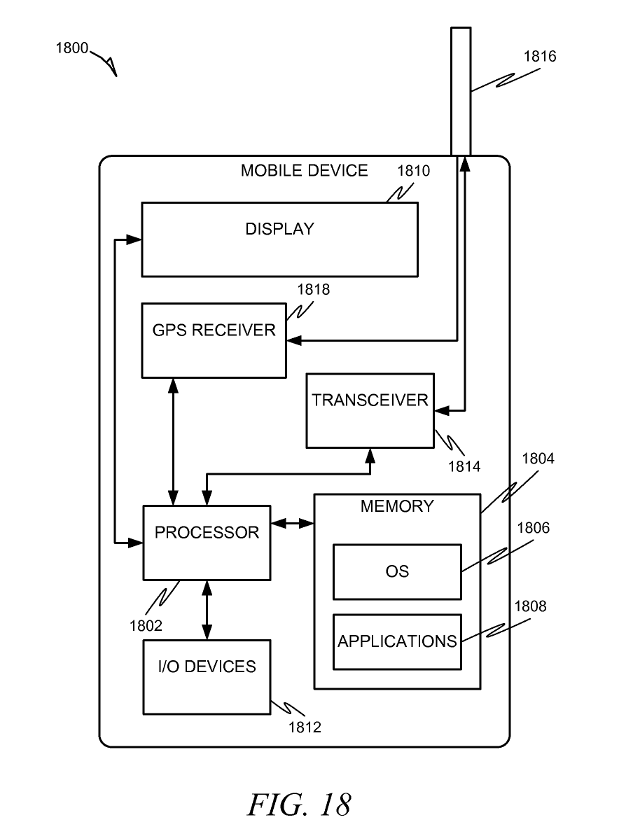

FIG. 18 is a block diagram illustrating a mobile device 1800, according to an example embodiment. The mobile device 1800 can include a processor 1802. The processor 1802 can be any of a variety of different types of commercially available processors suitable for mobile devices 1800 (for example, an XScale architecture microprocessor, a Microprocessor without Interlocked Pipeline Stages (MIPS) architecture processor, or another type of processor). A memory 1804, such as a random access memory (RAM), a Flash memory, or other type of memory, is typically accessible to the processor 1802. The memory 1804 can be adapted to store an operating system (OS) 1806, as well as application programs 1808, such as a mobile location enabled application that can provide LBSs to a user. The processor 1802 can be coupled, either directly or via appropriate intermediary hardware, to a display 1810 and to one or more input/output (I/O) devices 1812, such as a keypad, a touch panel sensor, a microphone, and the like. Similarly, in some example embodiments, the processor 1802 can be coupled to a transceiver 1814 that interfaces with an antenna 1816. The transceiver 1814 can be configured to both transmit and receive cellular network signals, wireless data signals, or other types of signals via the antenna 1816, depending on the nature of the mobile device 1800. Further, in some configurations, a GPS receiver 1818 can also make use of the antenna 1816 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

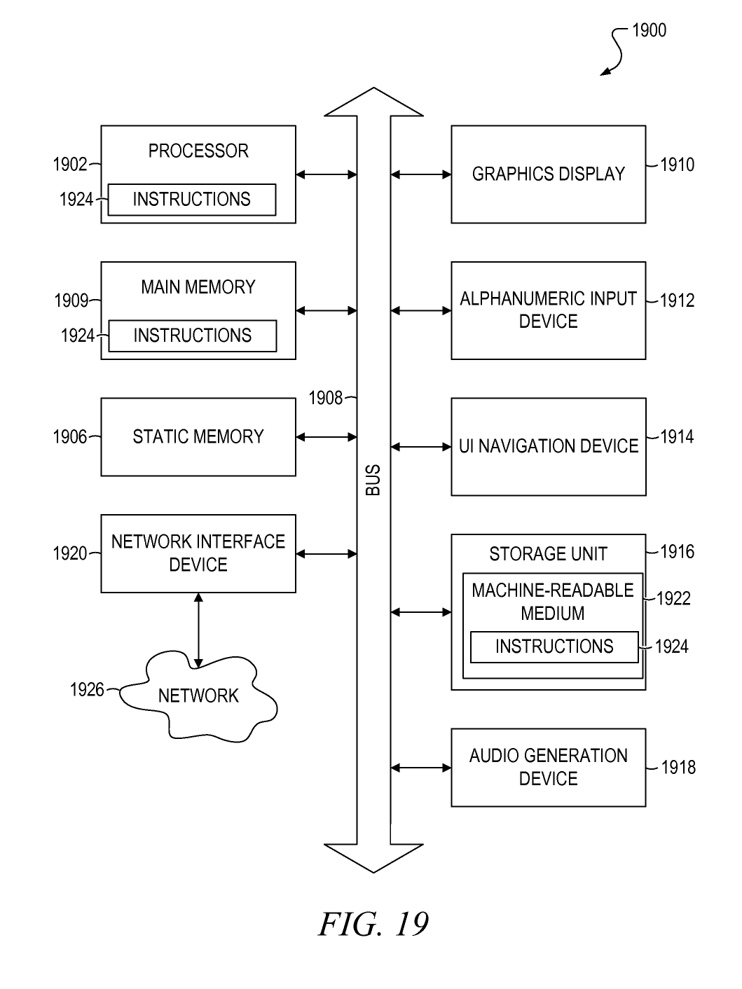

FIG. 19 is a block diagram of a machine in the example form of a computer system 1900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU) or both), a main memory 1904 and a static memory 1906, which communicate with each other via a bus 1908. The computer system 1900 may further include a graphics or video display unit 1910 (e.g., a liquid crystal display (LCD) or a cathode ray tube (CRT)). The computer system 1900 also includes an alphanumeric input device 1912 (e.g., a keyboard), a user interface (UI) navigation (or cursor control) device 1914 (e.g., a mouse), a storage unit (e.g., a disk drive unit) 1916, an audio or signal generation device 1918 (e.g., a speaker), and a network interface device 1920.

### Machine-Readable Medium

The storage unit 1916 includes a machine-readable medium 1922 on which is stored one or more sets of data structures and instructions 1924 (e.g., software) embodying or utilized by any one or more of the methodologies or functions described herein. The instructions 1924 may also reside, completely or at least partially, within the main memory 1904 and/or within the processor 1902 during execution thereof by the computer system 1900, the main memory 1904 and the processor 1902 also constituting machine-readable media. The instructions 1924 may also reside, completely or at least partially, within the static memory 1906.

While the machine-readable medium 1922 is shown in an example embodiment to be a single medium, the term “machine-readable medium” may include a single medium or multiple media (e.g., a centralized or distributed database, and/or associated caches and servers) that store the one or more instructions 1924 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1924 may further be transmitted or received over a communications network 1926 using a transmission medium. The instructions 1924 may be transmitted using the network interface device 1920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for selective gesture interaction using spatial volumes. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving a first indication of a first synchronous collaboration event for a first workspace;
storing a first record of the first synchronous collaboration event in association with the first workspace based on the first indication, the first record comprising first participant data indicating a first participant of the first synchronous collaboration event, first content data indicating content provided by the first participant during the first synchronous collaboration event, and first temporal data indicating a first time of occurrence of the first synchronous collaboration event;
receiving a second indication of a second asynchronous collaboration event for the first workspace;
storing a second record of the second asynchronous collaboration event in association with the first workspace based on the second indication, the second record comprising second participant data indicating a second participant of the second asynchronous collaboration event, second content data indicating content provided by the second participant during the second asynchronous collaboration event, and second temporal data indicating a second time of occurrence of the second asynchronous collaboration event; and
causing, by a machine having a memory and at least one processor, a first timeline for the first workspace to be displayed on a computing device, the first timeline comprising a first graphical representation of the first synchronous collaboration event based on the first record and a second graphical representation of the second asynchronous collaboration event based on the second record.

2. The computer-implemented method of claim 1, further comprising generating a workspace object corresponding to the first workspace based on a workspace object model, wherein storing the first record comprises storing the first synchronous collaboration event, the first participant data, and the first content data as shared objects of the workspace object, enabling users that are identified as participants of the first workspace to access and use the first synchronous collaboration event, the first participant data, and the first content data as content within a context of the first workspace.

3. The computer-implemented method of claim 2, wherein using the first synchronous collaboration event, the first participant data, and the first content data as content within the context of the first workspace comprises submitting comments to be stored in association with a corresponding one of the synchronous collaboration event, the first participant data, and the first content data, the comments being stored as shared objects of the first workspace.

4. The computer-implemented method of claim 2, wherein the workspace object model is configured to enable any shared objects of the first workspace to be associated with any other shared objects of the first workspace.

5. The computer-implemented method of claim 1, wherein:
storing the first record of the first synchronous collaboration event comprises generating and storing a first timeline event object based on a timeline event model, the first timeline event object being stored in association with the first workspace as part of the first record; and
storing the second record of the first asynchronous collaboration event comprises generating and storing a second timeline event object based on the timeline event model, the second timeline event object being stored in association with the first workspace as part of the second record,
wherein the timeline event model is configured to provide semantics for the first timeline event object and the second timeline event object, the semantics enabling a specification of a specific actor in a specific context of a specific workspace performed a specific action with respect to a specific workspace object at a specific time.

6. The computer-implemented method of claim 5, wherein the timeline event model is further configured to enable a view of the first timeline to be presented based on a specification of one or more elements of the semantics by a user.

7. The computer-implemented method of claim 1, wherein:
storing the first record comprises generating and storing a first actor object based on an actor model, the first actor object comprising the first participant data and being stored in association with the first workspace as part of the first record; and
storing the second record comprises generating and storing a second actor object based on the actor model; the second actor object comprising the second participant data and being stored in association with the first workspace as part of the first record,
wherein the actor model is configured to enable a distinction to be made between an actor being a general user of a platform and the actor being a participant of a specific workspace, the distinction being used to define a role for the actor, the role being used to determine what actions the actor is permitted to perform with respect to a workspace.

8. The computer-implemented method of claim 7, wherein the actor model is further configured to enable a specification of a non-human actor for a corresponding actor object.

9. The computer-implemented method of claim 1, wherein the content provided by the first participant during the first synchronous collaboration event comprises one of text from an online chat-based session event, a document uploaded by the first participant, audio from an audio-based session event, and video from a video-based session event.

10. The computer-implemented method of claim 1, wherein the content provided by the second participant during the second asynchronous collaboration event comprises one of text, a document, audio, and video.

11. The computer-implemented method of claim 1, wherein the first participant of the first synchronous collaboration event is different from the second participant of the second asynchronous collaboration event.

12. The computer-implemented method of claim 1, further comprising:
receiving a third indication of a third synchronous collaboration event for the first workspace; and
storing a third record of the third synchronous collaboration event in association with the first workspace based on the third indication, the third record comprising third participant data indicating a third participant of the third synchronous collaboration event, third content data indicating content provided by the third participant during the third synchronous collaboration event, and third temporal data indicating a third time of occurrence of the third synchronous collaboration event,
wherein the first timeline further comprises a third graphical representation of the third synchronous collaboration event based on the third record.

13. The computer-implemented method of claim 1, further comprising:
receiving a third indication of a third asynchronous collaboration event for the first workspace; and
storing a third record of the third asynchronous collaboration event in association with the first workspace based on the third indication, the third record comprising third participant data indicating a third participant of the third asynchronous collaboration event, third content data indicating content provided by the third participant during the third asynchronous collaboration event, and third temporal data indicating a third time of occurrence of the third asynchronous collaboration event,
wherein the first timeline further comprises a third graphical representation of the third asynchronous collaboration event based on the third record.

14. The computer-implemented method of claim 1, further comprising:
storing a corresponding record for each of a plurality of synchronous collaboration events and asynchronous collaboration events in association with a second workspace, each corresponding record comprising corresponding participant data indicating a corresponding participant of the corresponding collaboration event, corresponding content data indicating corresponding content provided by the corresponding participant during the corresponding collaboration event, and corresponding temporal data indicating a corresponding time of occurrence of the corresponding collaboration event; and
causing a second timeline for the second workspace to be displayed on the computing device, the timeline comprising a corresponding graphical representation for each of the plurality of synchronous collaboration events and asynchronous collaboration events based on their corresponding records.

15. The computer implemented method of claim 1, further comprising:
receiving, from a first user on the computing device, an identification of a second user different from the first user;
generating a list of workspaces for which the second user has been a participant based on the identification of the second user; and
causing the list of workspaces to be displayed to the first user on the computing device.

16. A system comprising:
a machine having at least one module, the at least one module comprising at least one processor and being configured to perform operations comprising:
receiving a first indication of a first synchronous collaboration event for a first workspace;
storing a first record of the first synchronous collaboration event in association with the first workspace based on the first indication, the first record comprising first participant data indicating a first participant of the first synchronous collaboration event, first content data indicating content provided by the first participant during the first synchronous collaboration event, and first temporal data indicating a first time of occurrence of the first synchronous collaboration event;
receiving a second indication of a second asynchronous collaboration event for the first workspace;
storing a second record of the second asynchronous collaboration event in association with the first workspace based on the second indication, the second record comprising second participant data indicating a second participant of the second asynchronous collaboration event, second content data indicating content provided by the second participant during the second asynchronous collaboration event, and second temporal data indicating a second time of occurrence of the second asynchronous collaboration event; and
causing a first timeline for the first workspace to be displayed on a computing device, the first timeline comprising a first graphical representation of the first synchronous collaboration event based on the first record and a second graphical representation of the second asynchronous collaboration event based on the second record.

17. The system of claim 16, wherein the operations further comprise generating a workspace object corresponding to the first workspace based on a workspace object model, wherein storing the first record comprises storing the first synchronous collaboration event, the first participant data, and the first content data as shared objects of the workspace object, enabling users that are identified as participants of the first workspace to access and use the first synchronous collaboration event, the first participant data, and the first content data as content within a context of the first workspace.

18. The system of claim 16, wherein:
storing the first record of the first synchronous collaboration event comprises generating and storing a first timeline event object based on a timeline event model, the first timeline event object being stored in association with the first workspace as part of the first record; and
storing the second record of the first asynchronous collaboration event comprises generating and storing a second timeline event object based on the timeline event model, the second timeline event object being stored in association with the first workspace as part of the second record,
the timeline event model is configured to provide semantics for the first timeline event object and the second timeline event object, the semantics enabling a specification of a specific actor in a specific context of a specific workspace performed a specific action with respect to a specific workspace object at a specific time.

19. The system of claim 16, wherein:
storing the first record comprises generating and storing a first actor object based on an actor model, the first actor object comprising the first participant data and being stored in association with the first workspace as part of the first record; and
storing the second record comprises generating and storing a second actor object based on the actor model; the second actor object comprising the second participant data and being stored in association with the first workspace as part of the first record,
wherein the actor model is configured to enable a distinction to be made between an actor being a general user of a platform and the actor being a participant of a specific workspace, the distinction being used to define a role for the actor, the role being used to determine what actions the actor is permitted to perform with respect to a workspace.

20. A non-transitory machine-readable storage medium, tangibly embodying a set of instructions that, when executed by at least one processor, causes the at least one processor to perform operations comprising:
receiving a first indication of a first synchronous collaboration event for a first workspace;
storing a first record of the first synchronous collaboration event in association with the first workspace based on the first indication, the first record comprising first participant data indicating a first participant of the first synchronous collaboration event, first content data indicating content provided by the first participant during the first synchronous collaboration event, and first temporal data indicating a first time of occurrence of the first synchronous collaboration event;
receiving a second indication of a second asynchronous collaboration event for the first workspace;
storing a second record of the second asynchronous collaboration event in association with the first workspace based on the second indication, the second record comprising second participant data indicating a second participant of the second asynchronous collaboration event, second content data indicating content provided by the second participant during the second asynchronous collaboration event, and second temporal data indicating a second time of occurrence of the second asynchronous collaboration event; and
causing a first timeline for the first workspace to be displayed on a computing device, the first timeline comprising a first graphical representation of the first synchronous collaboration event based on the first record and a second graphical representation of the second asynchronous collaboration event based on the second record.
